(19) United States
(12) Patent Application Publication
(10) Pub. No.: US 2013/0307819 A1
(43) Pub. Date: Nov. 21, 2013

(54) TOUCH PANEL SWITCH

(71) Applicant: KABUSHIKI KAISHA TOKAI RIKA DENKI SEISAKUSHO, Aichi (JP)

(72) Inventors: Tomomi SHIMIZU, Aichi (JP); Yuichiro SHIGEMATSU, Aichi (JP)

(73) Assignee: KABUSHIKI KAISHA TOKAI RIKA DENKI SEISAKUSHO, Aichi (JP)

(21) Appl. No.: 13/874,565

(22) Filed: May 1, 2013

(30) Foreign Application Priority Data
May 18, 2012 (JP) 2012-114256
Oct. 3, 2012 (JP) 2012-221165

(51) Int. Cl. G06F 3/044

(52) U.S. Cl. CPC G06F 3/044
USPC 345/174

(57) ABSTRACT

A touch panel switch includes a panel base including an operation surface on a front side thereof, a first electrode formed on a back side of the panel base, and a second electrode formed along the operation surface.

The present application is based on Japanese patent application Nos. 2012-114256 and 2012-221165 filed on May 18, 2012 and Oct. 3, 2012, respectively, the entire contents of which are incorporated herein by reference.

### BACKGROUND OF THE INVENTION

1. Field of the Invention

The invention relates to a touch panel switch and, in particular, to a capacitive touch panel switch having a three-dimensional appearance.

2. Related Art

Capacitive touch panel switches are frequently used in various electrical equipments for, e.g., vehicle or mobile device, etc. A panel switch described in, e.g., JP-A-2007-207531 has been proposed as an example of this type of conventional touch panel switch.

The conventional panel switch described in JP-A-2007-207531 has a laminated structure in which an electrode sheet having switch and GND electrodes formed on a PET film by printing silver paste is attached to a back side of a glass or acrylic panel by an adhesive.

### SUMMARY OF THE INVENTION

A capacitance of this type of panel switch is formed between an electrode arranged on a back side of a panel and a fingertip of an operator who performs touch-operation on a front side of the panel. In the conventional panel switch described in JP-A-2007-207531, if the panel surface is formed in a three-dimensional shape having a convex portion which obstructs close contact with the fingertip of the operator, it is difficult to obtain a sufficiently close contact of the fingertip of the operator with the convex portion. As a result, the capacitance formed between the electrode and the fingertip of the operator touch-operating the convex portion on the front side of the panel becomes small, which makes accurate touch detection difficult.

Meanwhile, even when the operation surface on the front side of the panel is formed of a flat planar portion, the capacitance formed between the electrode on the back side of the panel and the fingertip of the operator performing touch-operation on the operation surface becomes small when a distance between the operation surface on the front side of the panel and the electrode on the back side of the panel is large, which makes accurate touch detection difficult.

Accordingly, it is an object of the invention to provide a touch panel switch that has an improved accuracy in touch detection.

(1) According to one embodiment of the invention, a touch panel switch comprises:

a panel base comprising an operation surface on a front side thereof;

a first electrode formed on a back side of the panel base; and

a second electrode formed along the operation surface.

In the above embodiment (1) of the invention, the following modifications and changes can be made.
(i) An electrode area of the second electrode is set to be smaller than an electrode area of the first electrode and larger than a contact area of an object to be detected that is in contact with the operation surface.
(ii) The second electrode is formed on or under the operation surface.
(iii) A distance between the object to be detected in contact with the operation surface and the second electrode is set to be less than a distance between the first and second electrodes.
(iv) The operation surface comprises a raised portion.
(v) The second electrode is formed convex along the raised portion.

(vi) A capacitance formed between the first electrode and the second electrode is set to be less than a capacitance formed between the second electrode and a fingertip of an operator.
(vii) The second electrode is not electrically connected to the first electrode.
(viii) The touch panel switch further comprises a flexible wiring board, wherein the first electrode is formed on the flexible wiring board.
(ix) The touch panel switch further comprises a rigid wiring board, wherein the first electrode is formed on the rigid wiring board.

### POINTS OF THE INVENTION

According to one embodiment of the invention, a touch panel switch is constructed such that a sub-electrode as a second electrode which is not conducive to the other conductive part is added on the front side of a panel base. This allows an increase in capacitance of an electrode film (i.e., a convex portion as well as a portion other than the convex portion) on a top of the panel base. Thus, it is possible to suppress a variation in sensitivity of the touch panel switch.

### BRIEF DESCRIPTION OF THE DRAWINGS

Next, the present invention will be explained in more detail in conjunction with appended drawings, wherein:

FIGS. 1A and 1B are explanatory diagrams illustrating a touch panel switch in a first preferred embodiment of the present invention, wherein FIG. 1A is a schematic cross-sectional view and FIG. 1B is a plan view;

FIGS. 2A and 2B are schematic cross-sectional views for explaining a mechanism of capacitance when a fingertip of an operator is in contact with the touch panel switch, wherein FIG. 2A is a diagram illustrating an example of the touch panel switch in the first embodiment and FIG. 2B is a diagram illustrating an example of a touch panel switch in Comparative Example;

FIG. 3 is an explanatory schematic cross-sectional view showing a touch panel switch in a second embodiment;

FIG. 4 is an explanatory schematic cross-sectional view showing a touch panel switch in a third embodiment;

FIG. 5 is an explanatory schematic cross-sectional view showing a touch panel switch in a fourth embodiment; and

FIG. 6 is an explanatory schematic cross-sectional view showing a touch panel switch in a fifth embodiment.

### DESCRIPTION OF THE PREFERRED EMBODIMENTS

Preferred embodiments of the invention will be specifically described below in conjunction with the appended drawings. It should be noted that the drawings of the embodiments are not to actual scale and components constituting the touch panel switch are exaggeratingly depicted for easy understanding of features of the invention.

### First Embodiment

### Overall Structure of Touch Pad

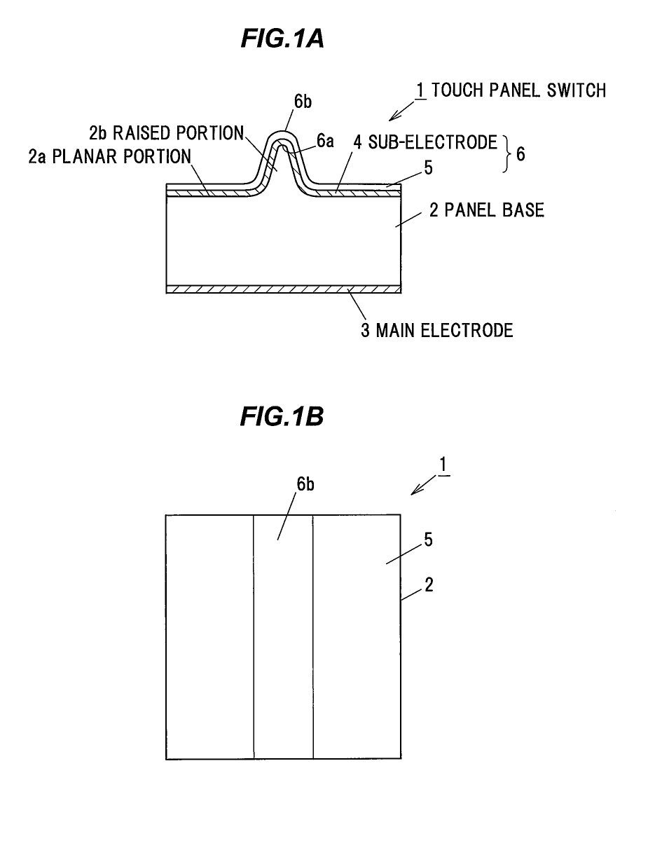

In FIGS. 1A and 1B, the reference numeral 1 generally indicates an example of a typical touch panel switch in the first embodiment. The touch panel switch 1 is used as a touch pad (touch panel) which detects change in capacitance as change in voltage when, e.g., an object to be detected such as a fingertip of an operator performs touch-operation on an operation surface.

As shown in FIGS. 1A and 1B, the touch panel switch 1 is provided with a panel base 2 which is a dielectric. An operation surface is formed on the panel base 2 and has a flat planar portion 2a and a rib-like raised portion 2b which is raised upward by a required height from a surface of the planar portion 2a. The external shape of the raised portion 2b is not particularly specified and may be, e.g., a convex shape, a step shape or a hemispherical shape.

As shown in FIGS. 1A and 1B, a main electrode 3 as a first electrode and a sub-electrode 4 as a second electrode are respectively formed on both sides of the panel base 2. The main electrode 3 is configured as an electrode on a detection circuit side and is formed in a required conductive pattern on a back side of the panel base 2. On the other hand, the sub-electrode 4 is configured as a part of an electrode film 6 in which a conductive material is formed on a protective base 5, and the sub-electrode 4 is joined and integrated with the panel base 2 along and directly below the operation surface including the planar portion 2a and the raised portion 2b.

As shown in FIGS. 1A and 1B, a concave-convex portion composed of a concave portion 6a and a convex portion 6b is formed on the electrode film 6 in a curved manner so as to correspond to the raised portion 2b of the panel base 2. The convex portion 6b is configured as an operation protrusion.

The panel base 2 and the protective base 5 may be formed of the same material, and a general film-like, sheet-like or plate-like material made of, e.g., a polyester-based resin or a polycarbonate-based resin is used.

The main electrode 3 and the sub-electrode 4 may also be formed of the same material. A commonly-used conductive material, e.g., metal such as gold, silver, copper and aluminum or conductive metal oxide such as transparent ITO (Indium Tin Oxide) is used and metal plating or conductive paste, etc., is applied or printed into a conductive film having a required shape, thereby forming a conductive pattern. It is possible to form a conductive pattern by deposition or sputtering, etc.

After placing the electrode film 6 as an insert article, a molten resin to be the panel base 2 is injection-molded in a molding space of a mold including the concave portion 6a, which allows the panel base 2 and the electrode film 6 to be laminated and integrated. As a result, the touch panel switch 1 having the electrode film 6 integrally molded with the panel base 2 is made.

Structure of Electrode Portion

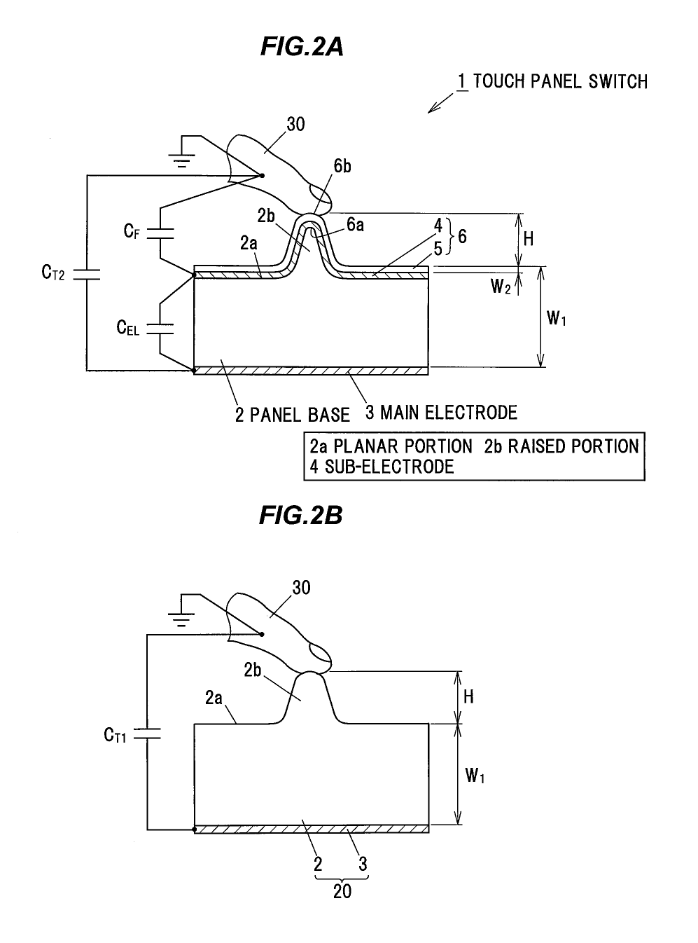

Referring to FIG. 2B, a mechanism of capacitance of a touch panel switch 20 in Comparative Example is illustrated as an example.

As shown in FIG. 2B, a capacitance C of the touch panel switch 20 in Comparative Example is formed between the main electrode 3 and a fingertip 30 of an operator performing touch-operation on the operation surface of the panel base 2 and has a characteristic of being determined by a contact area formed between the panel base 2 and the fingertip 30 of the operator, a thickness of the panel base 2 and a dielectric constant.

Assuming that the any air gap is not present between the main electrode 3 and the fingertip 30 of the operator and when calculated based on a plate capacitor model, the capacitance C generated by the fingertip 30 of the operator is expressed by a relation of C=(∈ᵣ×S)/D where a dielectric constant of an air layer is ∈₀, a relative dielectric constant of the panel base 2 is ∈ᵣ, a contact area of the fingertip 30 of the operator in contact with the raised portion 2b of the panel base 2 is S and a distance between the main electrode 3 and the fingertip 30 of the operator is D.

Due to this characteristic, in the touch panel switch 20 in Comparative Example shown in FIG. 2B, a capacitance C_{T1} formed between the main electrode 3 and the fingertip 30 of the operator becomes smaller in proportion to the contact area S of the fingertip 30 of the operator.

Accordingly, when the operation surface of the panel base 2 is formed in a three-dimensional shape having the raised portion 2b and close contact of the fingertip 30 of the operator with the raised portion 2b is obstructed due to the shape thereof, the capacitance C_{T1} becomes smaller in proportion to the contact area S touched by the fingertip 30. As a result, touch detection of the raised portion 2b having a small contact area becomes difficult.

On the other hand, due to the above-mentioned characteristic of the capacitance, the capacitance C formed between the main electrode 3 and the fingertip 30 of the operator becomes smaller as the distance D between the main electrode 3 and the fingertip 30 of the operator becomes larger.

Therefore, the most essential structure of the touch panel switch 1 in the first embodiment is an electrode structure which increases the capacitance generated by the fingertip 30 of the operator performing touch-operation of the planar portion 2a and the raised portion 2b of the panel base 2. Although the electrode structure of the raised portion 2b of the panel base 2 will be mainly described below, it is not limited thereto and it is obvious that the electrode structure of the planar portion 2a of the panel base 2 also has the same operational advantages.

In the first embodiment, the sub-electrode 4 of the electrode film 6 arranged along the surface of the panel base 2 is formed on a back surface of the protective base 5 opposite to the operation surface and is arranged between the back surface of the protective base 5 and the panel base 2, as shown in FIG. 2A. Wirings to the sub-electrode 4 from the main electrode 3 located on the detection circuit side of the panel base 2 or from the detection circuit are eliminated and the sub-electrode 4 is thus configured as an electrode which is formed of a conductive body but is not conducted to other conductive members.

It is important that a distance between the sub-electrode 4 and the fingertip 30 of the operator touching the operation surface of the panel base 2 is set to be smaller than a distance between the main electrode 3 and the sub-electrode 4. A capacitance C_{F} formed between the sub-electrode 4 and the fingertip 30 of the operator performing the touch-operation of the convex portion 6b of the electrode film 6 is set to be larger than a capacitance C_{EL} formed between the main electrode 3 and the sub-electrode 4, and a protrusion height H of the convex portion 6b of the electrode film 6 is set to be smaller than a thickness W₁ of the panel base 2.

As shown in FIG. 2A, an electrode area of the sub-electrode 4 is set to be equal to that of the main electrode 3 in order to ensure a sufficient active area of the main electrode 3 and is also set to be larger than a contact area of the fingertip 30 of the operator touching the operation surface of the panel base 2.

The following Table 1 shows change in capacitance of the touch panel switch 1 in a typical Example and that of the touch panel switch 20 in Comparative Example.

As shown in FIGS. 2A and 2B, the touch panel switches 1 and 20 in Example and Comparative Example are the same in the relative dielectric constant ∈ᵣ of the panel base 2, an electrode area S₁ of the main electrode 3, a contact area S₂ of the fingertip 30 of the operator in contact with the raised portion 2b of the panel base 2, a protrusion height H of the raised portion 2b of the panel base 2, and the thickness W₁ of the panel base 2.

Here, the electrode area S₁ of the main electrode 3 is 84.5 mm², the contact area S₂ of the fingertip 30 is 20 mm², the protrusion height H of the raised portion 2b is 0.5 mm, the thickness W₁ of the panel base 2 is 3 mm and the thickness W₂ of the protective base 5 of the electrode film 6 is 0.2 mm. It should be noted that the dimensions H, W₁ and W₂ in FIGS. 2A and 2B are shown to explain measurement spots on the touch panel switch 1 and may be not shown to the exact scale on the basis of the above-mentioned numerical values.

TABLE 1

| Capacitance | Comparative Example | Example |
|---|---|---|
| C_{T1} | 0.147 pF | — |
| C_{T2} | — | 0.523 pF |
| C_{F} | — | 2.568 pF |
| C_{EL} | — | 0.657 pF |

As obvious from Table 1, it is understood that a combined capacitance C_{T2} by combining the capacitance C_{EL} formed between the main electrode 3 and the sub-electrode 4 and the capacitance C_{F} formed between the sub-electrode 4 and the fingertip 30 of the operator performing the touch-operation of the convex portion 6b of the electrode film 6 can be increased in the touch panel switch 1 in Example as compared to the capacitance C_{T1} of the touch panel switch 20 in Comparative Example. It is possible to detect change in capacitance even when the operation surface of the panel base 2 is formed of only the planar portion 2a or is formed on a curved shape or a concave-convex shape, etc., other than the planar portion 2a and the raised portion 2b.

### Effects of the First Embodiment

In addition to the above-mentioned effects, the following various effects are obtained by employing the touch panel switch 1 configured as described above.

(1) Adding the sub-electrode 4, which is not conducive to the other conductive part, on the front side of the panel base 2 allows capacitance of the electrode film 6 at the convex portion 6b as well as a portion other than the convex portion 6b to be increased and it is thus possible to suppress variation in sensitivity of the touch panel switch 1.

(2) Since it is not necessary to wire from the main electrode 3 located on the detection circuit side of the panel base 2 or from the detection circuit to the sub-electrode 4 which is arranged on the planar portion 2a and the raised portion 2b of the panel base 2, it is possible to reduce structural restrictions.

(3) Since it is possible to properly detect the change in capacitance even on the operation surface having a three-dimensional shape, it is possible to ensure sensitivity of a touch input device.

(4) It is possible to increase capacitance by the sub-electrode 4 and it is thus possible to detect touch input within a contact area or a facing distance which is generally undetectable.

### Second Embodiment

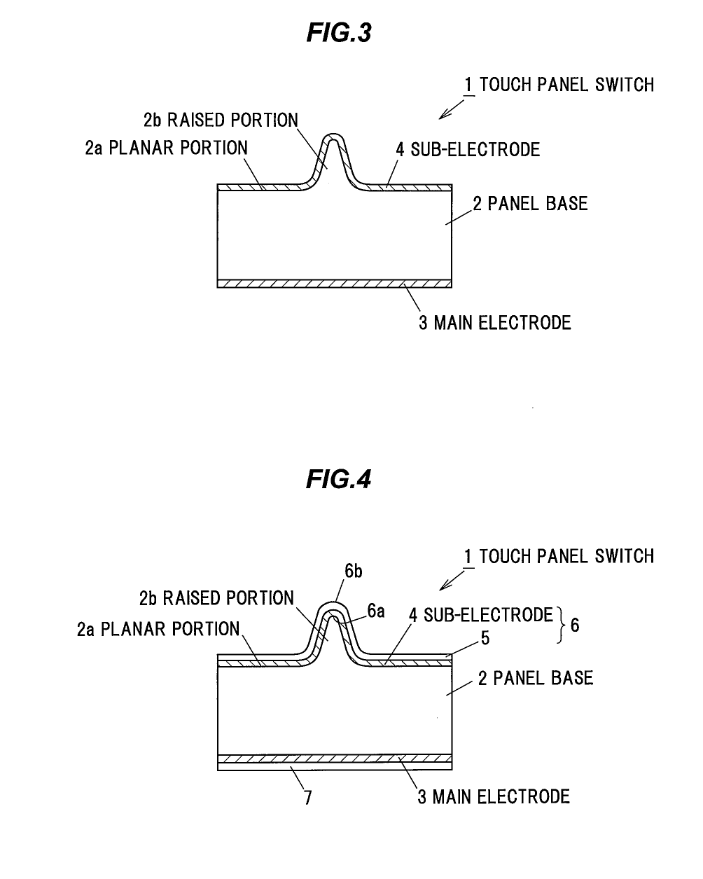

Referring to FIG. 3, a structural example of a touch panel switch in the second embodiment is shown. While the electrode film 6 is formed on the front side of the panel base 2 in the first embodiment, the second embodiment is different from the first embodiment in that the protective base 5 of the electrode film 6 is eliminated and only the sub-electrode 4 is formed along and just on the operation surface of the panel base 2.

The configuration other than the electrode structure formed on the front side of the panel base 2 is the same as the first embodiment. Therefore, substantially the same members as those in the first embodiment are denoted by the same names and reference numerals, and the detailed description thereof will be omitted.

In FIG. 3, an electrode film is formed on the surfaces of the planar portion 2a and the raised portion 2b of the panel base 2 by applying or printing metal plating or conductive paste, etc., thereby forming the sub-electrode 4. It is possible to form the sub-electrode 4 by, e.g., metal plating, deposition or sputtering of a commonly-used conductive material, e.g., metal such as copper or conductive metal oxide such as transparent ITO.

### Effects of the Second Embodiment

The same effects as the first embodiment are obtained also in the second embodiment configured as described above.

### Third Embodiment

Referring to FIG. 4, a structural example of a touch panel switch in the third embodiment is shown. The configuration of the third embodiment is the same as the first embodiment except that the main electrode 3 is formed on a flexible wiring board 7. Therefore, regarding FIG. 4, the detailed description of substantially the same members as those in the first embodiment will be omitted.

In FIG. 4, the reference numeral 7 indicates the flexible wiring board such as a FPC (flexible printed circuit) on which the main electrode 3 is formed. The FPC 7 may be formed of the same material as the protective base 5 of the electrode film 6, and a general film-like, sheet-like or plate-like material made of, e.g., a polyester-based resin or a polycarbonate-based resin is used. A commonly-used conductive material is used for the main electrode 3 in the same manner as the second embodiment.

The main electrode 3 is an electrode film formed by printing a conductive material on the FPC 7 into a required conductive pattern and is integrally laminated on the back side of the panel base 2 via a non-illustrated bonding-agent layer such as a double-sided tape, a sticky layer or an adhesive layer. Components constituting non-illustrated drive and control units for operating the touch panel switch 1 are mounted on the FPC 7.

### Effects of the Third Embodiment

In addition to the same effects as the first embodiment, components for operating the touch panel switch 1 can be formed on the FPC 7 by employing the touch panel switch 1 configured as described above.

### Fourth Embodiment

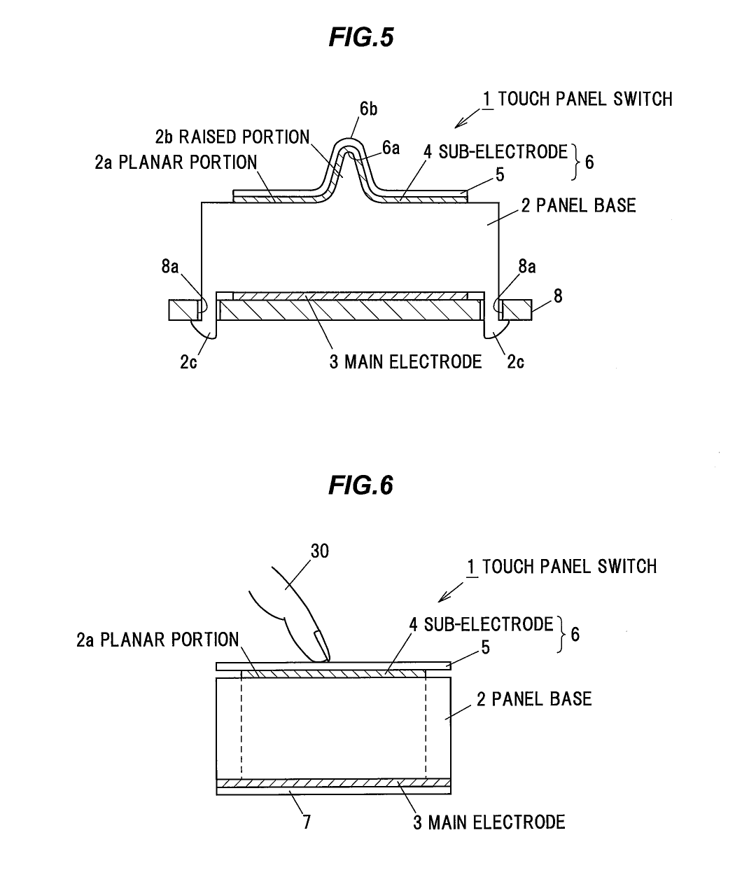

Referring to FIG. 5, a structural example of a touch panel switch in the fourth embodiment is shown. While the main electrode 3 is formed on the FPC 7 in the third embodiment, the fourth embodiment is different in that the main electrode 3 is formed on a rigid wiring board 8. Therefore, regarding FIG. 5, the detailed description of substantially the same members as those in the third embodiment will be omitted.

In FIG. 5, the reference numeral 8 indicates the rigid wiring board such as HPC (hard printed circuit). Fixing holes 8a are formed on the HPC 8 so as to penetrate therethrough. Fixing claw portions 2c for immovably supporting the HPC 8 are formed on a side wall of the panel base 2. The panel base 2 and the HPC 8 are closely integrated by fitting and fixing the fixing claw portions 2c to the fixing holes 8a. As a means of fixing to the HPC 8, it is possible to use other fasteners such as screw instead of using the fixing claw portions 2c.

An electrode film is formed on the HPC 8 by applying or printing metal plating or conductive paste, etc. into a predetermined shape, thereby forming the main electrode 3. The conductive pattern of the main electrode 3 may be formed by, e.g., deposition or sputtering of a commonly-used conductive material, e.g., metal such as copper or conductive metal oxide such as transparent ITO. For example, an epoxy-based resin, etc., is used as a material of the HPC 8.

### Effects of the Fourth Embodiment

In addition to the same effects as the first embodiment, components constituting non-illustrated drive and control units for operating the touch panel switch 1 can be mounted on the HPC 8 by employing the touch panel switch 1 configured as described above.

### Fifth Embodiment

Referring to FIG. 6, a structural example of a touch panel switch in the fifth embodiment is shown. Note that, regarding FIG. 6, the detailed description of substantially the same members as those in the first to fourth embodiments will be omitted.

While the electrode area of the sub-electrode 4 is set to be equal to that of the main electrode 3 as well as larger than the contact area of the fingertip 30 of the operator in the first to fourth embodiments, the fifth embodiment is different in that the electrode area of the sub-electrode 4 is set to be smaller than that of the main electrode 3. In the illustrated example, a tip of a nail of the operator is illustrated as an example of an object to be detected of which contact area with respect to the sub-electrode 4 is small.

As shown in FIG. 6, the main electrode 3 and the sub-electrode 4 are respectively formed on both sides of the panel base 2. The sub-electrode 4 is formed to have a smaller electrode area than the main electrode 3 and is joined to and integrated with the panel base 2, along the planar portion 2a. By setting the electrode area of the sub-electrode 4 to be smaller than that of the main electrode 3 as well as larger than the contact area with the object to be detected, an active area of the main electrode 3 is increased.

### Effects of the Fifth Embodiment

In addition to the effects described above, employing the touch panel switch 1 configured as described above allows the electrode area of the main electrode 3 to be effectively used even though the electrode area of the sub-electrode 4 is smaller than that of the main electrode 3, and also allows touch capacitance to be detected as long as the fingertip of the operator touches even slightly, regardless of the size of the object to be detected. Note that, it is obvious that this is applicable to the sub-electrode 4 which corresponds to the raised portion 2b of the panel base 2.

Modifications

For example, the following modifications can be made in each of the embodiments.

(1) It is obvious that the shape or size, etc., of the panel base 2 can be appropriately determined depending on intended purpose, location of use and specific use, etc., and the panel base 2 may be a member formed in various outer shapes such as a planar surface, a combination of curved and planar surfaces or a combination of planar surfaces.

(2) It is obvious that the shape, size, layout position and number, etc., of the raised portions 2b of the panel base 2 can be also appropriately determined depending on intended purpose, location of use and specific use, etc.

(3) It is possible to install to various vehicle interiors having a three-dimensional shape such as instrument panel, steering wheel and center console between a driver's seat and a front passenger seat.

(4) It is obvious that it is possible to effectively use the touch panel switch 1 as an input device of various portable information terminal devices such as input system for remote control of on-board units, mobile phones or cameras.

Although the touch panel switch 1 of the invention has been described based on the embodiments, modifications and illustrated examples, it is obvious from the above description that the invention is not intended to be limited to the embodiments, modifications and illustrated examples, and can be implemented in various forms without departing from the gist of the invention.

Furthermore, in the present invention, all combinations of the features described in the embodiments, modifications and illustrated examples are not necessary to solve the problem of the invention.

What is claimed is:

1. A touch panel switch, comprising:
a panel base comprising an operation surface on a front side thereof;
a first electrode formed on a back side of the panel base; and
a second electrode formed along the operation surface.

2. The touch panel switch according to claim 1, wherein an electrode area of the second electrode is set to be smaller than an electrode area of the first electrode and larger than a contact area of an object to be detected that is in contact with the operation surface.

3. The touch panel switch according to claim 1, wherein the second electrode is formed on or under the operation surface.

4. The touch panel switch according to claim 1, wherein a distance between the object to be detected in contact with the operation surface and the second electrode is set to be less than a distance between the first and second electrodes.

5. The touch panel switch according to claim 1, wherein the operation surface comprises a raised portion.

6. The touch panel switch according to claim 5, wherein the second electrode is formed convex along the raised portion.

7. The touch panel switch according to claim 1, wherein a capacitance formed between the first electrode and the second electrode is set to be less than a capacitance formed between the second electrode and a fingertip of an operator.

8. The touch panel switch according to claim 1, wherein the second electrode is not electrically connected to the first electrode.

9. The touch panel switch according to claim 1, further comprising a flexible wiring board,
wherein the first electrode is formed on the flexible wiring board.

10. The touch panel switch according to claim 1, further comprising a rigid wiring board,
wherein the first electrode is formed on the rigid wiring board.
